(19) United States
(12) Patent Application Publication
(10) Pub. No.: US 2013/0202835 A1
(43) Pub. Date: Aug. 8, 2013

(54) HARDCOAT FILMS FOR GRAPHIC SUBSTRATES

(71) Applicants: Robert R. Condon, Woodbury, MN (US); John P. Baetzold, North St. Paul, MN (US); John J. Stradinger, Roseville, MN (US); Hildegard Maurer-Johannsen, Viersen (DE)

(72) Inventors: Robert R. Condon, Woodbury, MN (US); John P. Baetzold, North St. Paul, MN (US); Heiner Johannsen, Viersen (DE); John J. Stradinger, Roseville, MN (US)

(21) Appl. No.: 12/744,582

(22) PCT Filed: Nov. 26, 2008
(86) PCT No.: PCT/US08/84798

§ 371 Date: Nov. 10, 2010

Related U.S. Application Data
(60) Provisional application No. 60/990,848, filed on Nov. 28, 2007.

(51) Int. Cl. B32B 27/08; B32B 27/30; B32B 27/40

(52) U.S. Cl. CPC B32B 27/08; B32B 27/40; B32B 27/308
USPC 428/41.3; 427/207.1; 428/335; 428/141; 428/423.1; 428/216

(57) ABSTRACT

The present application is directed to a hardcoat film article comprising a cured hardcoat layer disposed on a release liner, and a thermoplastic layer on the cured hardcoat layer opposite the release liner. The thermoplastic layer has a thickness of at least about 25 micrometers. In other embodiment, the thermoplastic layer is opaque. The release liner comprising a release material formed by irradiating a release material precursor. Additionally, this application is directed to a method of forming a composite film comprising providing a release liner, coating a hardcoat composition onto the release liner to form a hardcoat layer, and curing the hardcoat layer to form a cured hardcoat layer. A thermoplastic layer is disposed onto the cured hardcoat layer to form a hardcoat composite film, and the hardcoat composite film is attached to an adhesive layer opposite the cured hardcoat layer.

### FIELD

The present invention relates to hardcoat articles having a cured hardcoat layer disposed on a release liner that can be used, for example, in graphic applications, and to methods of making and using the hardcoat articles.

### BACKGROUND

Graffiti resistant protection products for the graphics industry consist mainly of films and clear coats that overlay graphic substrates. While these products provide some level of protection to the graphic substrate, they each have limitations. Protective films often fail to provide proper scratch or stain resistance, and/or are often brittle. Clear coats often embrittle the protected film, making removal of the protected film difficult. Improved graffiti resistant protection products are desired.

### SUMMARY

In one embodiment, the present application is directed to a hardcoat film article comprising a cured hardcoat layer disposed on a release liner, and a thermoplastic layer on the cured hardcoat layer opposite the release liner, the release liner comprising a release material formed by irradiating a release material precursor, wherein the thermoplastic layer has a thickness of at least about 25 micrometers. In this embodiment, the release material precursor has a shear storage modulus of about 1×10² to about 3×10⁶ Pa when measured at 20° C. and at a frequency of 1 Hz, and the release material has a contact angle of 15° or more, as measured using a mixed solution of methanol and water (volume ratio 90:10) having a wet tension of 25.4 mN/m.

In another embodiment, the present application is directed to a hardcoat film article comprising a cured hardcoat layer disposed on a release liner, and a thermoplastic layer on the cured hardcoat layer opposite the release liner, the release liner comprising a release material formed by irradiating a release material precursor, wherein the thermoplastic layer is opaque. In this embodiment, the release material precursor has a shear storage modulus of about 1×10² to about 3×10⁶ Pa when measured at 20° C. and at a frequency of 1 Hz, and the release material has a contact angle of 15° or more, as measured using a mixed solution of methanol and water (volume ratio 90:10) having a wet tension of 25.4 mN/m.

Additionally, this application is directed to a method of forming a composite film comprising providing a release liner, coating a hardcoat composition onto the release liner to form a hardcoat layer, curing the hardcoat layer to form a cured hardcoat layer, disposing an opaque thermoplastic layer onto the cured hardcoat layer to form a hardcoat composite film, and attaching the hardcoat composite film to an adhesive layer opposite the cured hardcoat layer.

Another embodiment includes method of forming a composite film comprising providing a release liner, coating a hardcoat composition onto the release liner to form a hardcoat layer, curing the hardcoat layer to form a cured hardcoat layer, disposing a thermoplastic layer onto the cured hardcoat layer to form a hardcoat composite film. And attaching the hardcoat composite film to an adhesive layer opposite the cured hardcoat layer. In such an embodiment, the thermoplastic layer has a thickness of at least 25 micrometers.

These and other aspects of the transfer hardcoat films according to the subject invention will become readily apparent to those of ordinary skill in the art from the following detailed description together with the drawings.

### BRIEF DESCRIPTION OF THE DRAWINGS

So that those having ordinary skill in the art to which the subject invention pertains will more readily understand how to make and use the subject invention, exemplary embodiments thereof will be described in detail below with reference to the drawings, in which:

FIG. 1 is a schematic diagram of a hardcoat film article of the invention.

FIG. 2 is a schematic diagram of a hardcoat film article of the invention comprising a thermoplastic layer.

FIG. 3 is a schematic diagram of a hardcoat film article of the invention comprising an adhesive layer and an optional second release liner.

### DETAILED DESCRIPTION

The present disclosure is directed to hardcoat composite films for graphic substrates, and particularly to cured hardcoat films that can be applied to substrates to provide graffiti, scratch resistance and/or conformability.

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a layer” encompasses embodiments having one, two or more layers. As used in this specification and the appended claims, the term “or” is generally employed in its sense including “and/or” unless the content clearly dictates otherwise.

The term “polymer” will be understood to include polymers, copolymers (e.g., polymers formed using two or more different monomers), oligomers and combinations thereof, as well as polymers, oligomers, or copolymers that can be formed in a miscible blend.

The term “transparent film” refers to a film having a thickness and when the film is disposed on a substrate, an image (disposed on or adjacent to the substrate) is visible through the thickness of the transparent film. In many embodiments, a transparent film allows the image to be seen through the thickness of the film without substantial loss of image clarity. In some embodiments, the transparent film has a matte or glossy finish.

The term “opaque” refers to a film that blocks light so as not be to transparent.

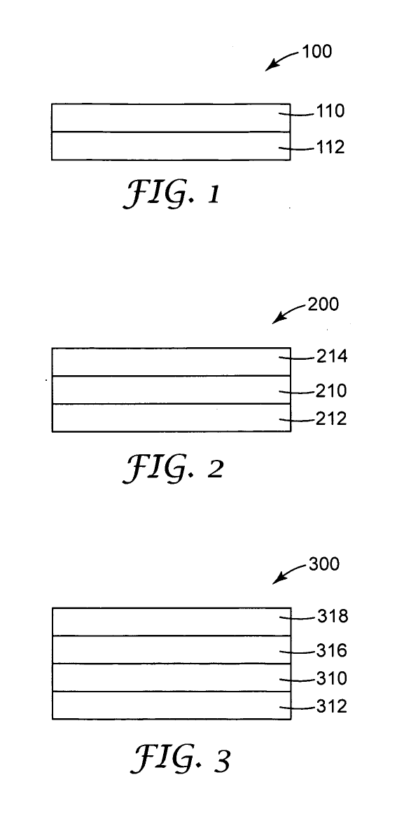

FIG. 1 depicts a hardcoat film article of the invention. Hardcoat film article 100 includes cured hardcoat layer 110 disposed on release liner 112. A hardcoat solution can be coated onto release liner 112 using coating methods known in the art. The hardcoat solution can be coated from an emulsion, a solvent (for example, organic solvent) mixture, or as 100% solids onto release liner 112.

The thickness of cured hardcoat layer 110 can be any useful thickness. In some embodiments, cured hardcoat layer 110 has a thickness in a range from about 1 to about 25 micrometers (for example about 1 to about 15; and in some embodiments about 1 to about 10, and in specific embodiments from about 1 to about 5 micrometers).

The hardcoat film articles of the invention further comprises a thermoplastic layer. As illustrated in FIG. 2, hardcoat film article 200 comprises thermoplastic layer 214 disposed on cured hardcoat layer 210. Thermoplastic layer 214 is generally opaque. Suitable thermoplastic polymers include polyacrylates or a derivative thereof, polypropylene, polyacetal, polyamide, polyester, polystyrene, polyvinyl chloride, polyvinylidene chloride, polyurethane, polyurea, and the like, In some embodiment, the thermoplastic polymer may include a pigment within the thermoplastic polymer to give the polymer layer a color. For example, a white film.

The thickness of thermoplastic layer 214 can be any useful thickness. In some embodiments, thermoplastic layer 214 has a thickness of at least about 25 micrometers. In some embodiments, the thermoplastic layer is at least about 50 micrometers. Generally, the thermoplastic layer is less than about 100 micrometers.

The thermoplastic layer 214 is bonded directly to the cured hardcoat by any method known in the art. Methods include extrusion coating, laminating and casting. In many embodiments, the thermoplastic layer is cast onto the cured hardcoat.

Thermoplastic layer 214 can include an ink receptive material or thermoplastic layer 214 can include an ink receptive layer. An ink receptive layer or material is a layer or material is a layer or material that is receptive to UV ink and/or solvent-based ink jet ink. As used herein, “solvent-based” means non-aqueous. An ink receptive layer includes a blend of a carrier resin and an ink absorptive resin. The carrier resins described herein are thermoplastic polymers. The carrier resin can be any thermoplastic resin or blend of resins that is compatible with the ink absorptive resin. A specific embodiment of an ink receptive material can be found, for example, in co pending U.S. patent application Ser. No. 11/427/575, incorporated by reference herein.

The image described herein can be formed on the thermoplastic layer/ink receptive layer via any useful printing method such as, for example, a solvent based ink jet printing process, a thermal mass transfer printing process, electrostatic printing, gravure printing, offset printing, screen printing, and the like. Solvent based printing processes allow for the image to be formed of a thermoplastic material. This ink can include an organic solvent, a thermoplastic material, and a pigment. The organic solvents can include any organic solvent useful for solubilizing the thermoplastic ink material and includes, for example, ketones, glycol ethers, esters, and the like. The pigment can include any pigment useful for providing color to the ink and are known in the ink jet field.

Surface treatments can sometimes be useful to secure adhesion between thermoplastic layer 214 (and/or ink receptor layer) and cured hardcoat layer 210. Surface treatments include, for example, chemical priming, corona treatment, plasma or flame treatment. A chemical primer layer or a corona treatment layer can be disposed between thermoplastic layer 214 (and/or ink receptor layer) and cured hardcoat layer 210. A chemical primer layer or a corona treatment layer can be disposed on one or both thermoplastic layer 214 (and/or ink receptor layer) and cured hardcoat layer 210. When a chemical primer layer and/or corona treatment is employed, inter-layer adhesion between thermoplastic layer 214 (and/or ink receptor layer) and cured hardcoat layer 210, can be improved.

Suitable chemical primer layers can be selected from urethanes, silicones, epoxy resins, vinyl acetate resins, ethyleneimines, and the like. Examples of chemical primers for vinyl and polyethylene terephthalate films include crosslinked acrylic ester/acrylic acid copolymers disclosed in U.S. Pat. No. 3,578,622. The thickness of the chemical primer layer is suitably within the range of about 10 to about 3,000 nanometers.

Corona treatment is a useful physical priming suitably applied to cured hardcoat layer 210 onto which is then coated thermoplastic layer 214 (and/or ink receptor layer). Corona treatment (or coating an additional prime layer) can improve the inter-layer adhesion between thermoplastic layer 214 and cured hardcoat layer 210.

An adhesive layer can be disposed on at least a portion of the cured hardcoat layer, as illustrated in FIG. 3. Hardcoat film article 300 includes cured hardcoat layer 310 disposed on release liner 312 and adhesive layer 316 (and an optional second release liner 318) disposed on cured hardcoat layer 310. Optional second release liner 318 can be removed to reveal adhesive layer 316 so that adhesive layer 316 can be used to adhere hardcoat film article 300 to a substrate. Once hardcoat film article 300 is adhered to a substrate, release liner 312 can be removed. Illustrative substrates includes for example, building surfaces, vehicle surfaces or other graphic display surfaces.

To enhance durability of the ink receptive thermoplastic layer and/or thermoplastic layer, especially in outdoor environments exposed to sunlight, a variety of commercially available stabilizing chemicals can be added. These stabilizers can be grouped into the following categories: heat stabilizers, ultraviolet (UV) light stabilizers, and free-radical scavengers. Heat stabilizers are commercially available from Witco Corp., Greenwich, Conn. under the trade designation “Mark V 1923” and Ferro Corp., Polymer Additives Div., Walton Hills, Ohio under the trade designations “Synpron 1163”, “Ferro 1237” and “Ferro 1720”. Such heat stabilizers can be present in amounts ranging from 0.02 to 0.15 weight percent. UV light stabilizers can be present in amounts ranging from 0.1 to 5 weight percent. Benzophenone type UV-absorbers are commercially available from BASF Corp., Parsippany, N.J. under the trade designation “Uvinol 400”; Cytec Industries, West Patterson, N.J. under the trade designation “Cyasorb UV1164” and Ciba Specialty Chemicals, Tarrytown, N.Y., under the trade designations “Tinuvin 900”, “Tinuvin 123” and “Tinuvin 1130”. Free-radical scavengers can be present in an amount from 0.05 to 0.25 weight percent. Nonlimiting examples of free-radical scavengers include hindered amine light stabilizer (HALS) compounds, hydroxylamines, sterically hindered phenols, and the like. HALS compounds are commercially available from Ciba Specialty Chemicals under the trade designation “Tinuvin 292” and Cytec Industries under the trade designation “Cyasorb UV3581”. In general, the ink receptive layer and/or thermoplastic layer can be substantially free of colorant until it is printed with an image. However, it may also contain colorants to provide a uniform background colored film.

The cured hardcoat layer may be made from any suitably curable polymeric material. An example of a suitable material for the cured hardcoat layer is a multi-functional or cross-linkable monomer. Illustrative cross-linkable monomers include multi-functional acrylates, urethanes, urethane acrylates, siloxanes, and epoxies. In some embodiments, cross-linkable monomers include mixtures of multifunctional acrylates, urethane acrylates, or epoxies. In some embodiments, the cured hardcoat layer 120 includes a plurality of inorganic nanoparticles. The inorganic nanoparticles can include, for example, silica, alumina, or zirconia nanoparticles. In some embodiments, the nanoparticles have a mean diameter in a range from 1 to 200 nm, or 5 to 150 nm, or 5 to 125 nm. In illustrative embodiments, the nanoparticles can be “surface modified” such that the nanoparticles provide a stable dispersion in which the nanoparticles do not agglomerate after standing for a period of time, such as 24 hours, under ambient conditions.

The thickness of the cured hardcoat layer can be any useful thickness. In some embodiments, the cured hardcoat layer has a thickness of 1 to 25 micrometers. In another embodiment, cured hardcoat layer has a thickness of 1 to 15 micrometers. In another embodiment, cured hardcoat layer has a thickness of 1 to 10 micrometers. In another embodiment, cured hardcoat layer has a thickness of 1 to 5 micrometers.

Useful acrylates for the hardcoat layer include, for example, poly (meth)acryl monomers such as, for example, (a) di(meth)acryl containing compounds such as 1,3-butylene glycol diacrylate, 1,4-butanediol diacrylate, 1,6-hexanediol diacrylate, 1,6-hexanediol monoacrylate monomethacrylate, ethylene glycol diacrylate, alkoxylated aliphatic diacrylate, alkoxylated cyclohexane dimethanol diacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, hydroxypivalaldehyde modified trimethylolpropane diacrylate, neopentyl glycol diacrylate, polyethylene glycol (200) diacrylate, polyethylene glycol (400) diacrylate, polyethylene glycol (600) diacrylate, propoxylated neopentyl glycol diacrylate, tetraethylene glycol diacrylate, tricyclodecanedimethanol diacrylate, triethylene glycol diacrylate, tripropylene glycol diacrylate; (b) tri(meth)acryl containing compounds such as glycerol triacrylate, trimethylolpropane triacrylate, ethoxylated triacrylates (e.g., ethoxylated (3) trimethylolpropane triacrylate, ethoxylated (6) trimethylolpropane triacrylate, ethoxylated (9) trimethylolpropane triacrylate, ethoxylated (20) trimethylolpropane triacrylate), pentaerythritol triacrylate, propoxylated triacrylates (e.g., propoxylated (3) glyceryl triacrylate, propoxylated (5.5) glyceryl triacrylate, propoxylated (3) trimethylolpropane triacrylate, propoxylated (6) trimethylolpropane triacrylate), trimethylolpropane triacrylate, tris(2-hydroxyethyl)isocyanurate triacrylate; (c) higher functionality (meth)acryl containing compounds such as ditrimethylolpropane tetraacrylate, dipentaerythritol pentaacrylate, ethoxylated (4) pentaerythritol tetraacrylate, pentaerythritol tetraacrylate, caprolactone modified dipentaerythritol hexaacrylate; (d) oligomeric (meth)acryl compounds such as, for example, urethane acrylates, polyester acrylates, epoxy acrylates; polyacrylamide analogues of the foregoing such as, for example, N,N-dimethyl acrylamide; and combinations thereof. Such compounds are widely available from vendors such as, for example, Sartomer Company, Exton, Pa.; UCB Chemicals Corporation, Smyrna, Ga.; and Aldrich Chemical Company, Milwaukee, Wis. Additional useful (meth)acrylate materials include hydantoin moiety-containing poly(meth)acrylates, for example, as described in U.S. Pat. No. 4,262,072 (Wendling et al.).

In an illustrative embodiment, the curable hardcoat layer includes a monomer having at least two or three (meth)acrylate functional groups. Commercially available cross-linkable acrylate monomers include those available from Sartomer Company, Exton, Pa. such as trimethylolpropane triacrylate available under the trade designation “SR351”, pentaerythritol triacrylate available under the trade designation “SR444”, dipentaerythritol triacrylate available under the trade designation “SR399LV”, ethoxylated (3) trimethylolpropane triacrylate available under the trade designation “SR454”, ethoxylated (4) pentaerythritol triacrylate, available under the trade designation “SR494”, tris(2-hydroxyethyl)isocyanurate triacrylate, available under the trade designation “SR368”, and dipropylene glycol diacrylate, available under the trade designation “SR508”.

Useful urethane acrylate monomers include, for example, a hexafunctional urethane acrylate available under the tradename Ebecryl 8301 from Radcure UCB Chemicals, Smyrna, Ga., CN981 and CN981B88 available from Sartomer Company, Exton, Pa., and a difunctional urethane acrylate available under the tradename Ebecryl 8402 from Radcure UCB Chemicals, Smyrna, Ga. In some embodiments the hardcoat layer resin includes both poly(meth)acrylate and polyurethane material, which can be termed a “urethane acrylate.”

In some embodiments, the nanoparticles are inorganic nanoparticles such as, for example, silica, alumina, or zirconia. Nanoparticles can be present in an amount from 10 to 200 parts per 100 parts of hardcoat layer monomer. Silicas for use in the materials of the invention are commercially available from Nalco Chemical Co. (Naperville, Ill.) under the product designation NALCO COLLOIDAL SILICAS. For example, silicas include NALCO products 1040, 1042, 1050, 1060, 2327 and 2329. Zirconia nanoparticles are commercially available from Nalco Chemical Co. (Naperville, Ill.) under the product designation NALCO OOSSOO8.

Surface treating or surface modification of the nano-sized particles can provide a stable dispersion in the hardcoat layer resin. The surface-treatment can stabilize the nanoparticles so that the particles will be well dispersed in the polymerizable resin and result in a substantially homogeneous composition. Furthermore, the nanoparticles can be modified over at least a portion of its surface with a surface treatment agent so that the stabilized particle can copolymerize or react with the polymerizable hardcoat layer resin during curing.

The nanoparticles can be treated with a surface treatment agent. In general a surface treatment agent has a first end that will attach to the particle surface (covalently, ionically or through strong physisorption) and a second end that imparts compatibility of the particle with the hardcoat layer resin and/or reacts with hardcoat layer resin during curing. Examples of surface treatment agents include alcohols, amines, carboxylic acids, sulfonic acids, phosphohonic acids, silanes and titanates. The preferred type of treatment agent is determined, in part, by the chemical nature of the inorganic particle or metal oxide particle surface. Silanes are generally preferred for silica and zirconia (the term “zirconia” includes zirconia metal oxide.) The surface modification can be done either subsequent to mixing with the monomers or after mixing.

In some embodiment, it is preferred to react silanes with the particle or nanoparticle surface before incorporation into the resin. The required amount of surface modifier is dependant upon several factors such as particle size, particle type, modifier molecular wt, and modifier type. In general it is preferred that approximately a monolayer of modifier is attached to the surface of the particle. The attachment procedure or reaction conditions required also depend on the surface modifier used. For silanes it is preferred to surface treat at elevated temperatures under acidic or basic conditions for approximately 1-24 hours approximately. Surface treatment agents such as carboxylic acids do not require elevated temperatures or extended time.

Surface modification of zirconia (ZrO₂) with silanes can be accomplished under acidic conditions or basic conditions. In one embodiment, silanes are preferably heated under acid conditions for a suitable period of time. At which time the dispersion is combined with aqueous ammonia (or other base). This method allows removal of the acid counter ion from the ZrO₂ surface as well as reaction with the silane. Then the particles are precipitated from the dispersion and separated from the liquid phase.

The surface modified particles can be incorporated into the curable resin by various methods. In one embodiment, a solvent exchange procedure is utilized whereby the resin is added to the surface modified nanoparticles, followed by removal of the water and co-solvent (if used) via evaporation, thus leaving the particles dispersed in the polyerizable resin. The evaporation step can be accomplished for example, via distillation, rotary evaporation or oven drying, as desired.

Representative embodiments of surface treatment agents suitable for inclusion in the hardcoat layer include compounds such as, for example, phenyltrimethoxysilane, phenyltriethoxysilane, 2-(3,4-epoxycyclohexyl)ethyltriethoxysilane, 2-(3,4-epoxycyclohexyl)ethyltrimethoxysilane, isooctyl trimethoxy-silane, N-(3-triethoxysilylpropyl) methoxyethoxyethoxyethyl carbamate (PEG3TES), Silquest A1230, N-(3-triethoxysilylpropyl) methoxyethoxyethoxyethyl carbamate (PEG2TES), 3-(methacryloyloxy)propyltrimethoxysilane, 3-acryloxypropyltrimethoxysilane, 3-(methacryloyloxy)propyltriethoxysilane, 3-(methacryloyloxy) propylmethyldimethoxysilane, 3-(acryloyloxypropyl)methyldimethoxysilane, 3-(methacryloyloxy)propyldimethylethoxysilane, 3-(methacryloyloxy) propyldimethylethoxysilane, vinyldimethylethoxysilane, phenyltrimethoxysilane, n-octyltrimethoxysilane, dodecyltrimethoxysilane, octadecyltrimethoxysilane, propyltrimethoxysilane, hexyltrimethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, styrylethyltrimethoxysilane, mercaptopropyltrimethoxysilane, 3-glycidoxypropyltrimethoxysilane, acrylic acid, methacrylic acid, oleic acid, stearic acid, dodecanoic acid, 2-[2-(2-methoxyethoxy)ethoxy]acetic acid (MEEAA), beta-carboxyethylacrylate, 2-(2-methoxyethoxy)acetic acid, methoxyphenyl acetic acid, and mixtures thereof.

A photoinitiator can be included in the hardcoat layer. Examples of initiators include, organic peroxides, azo compounds, quinines, nitro compounds, acyl halides, hydrazones, mercapto compounds, pyrylium compounds, imidazoles, chlorotriazines, benzoin, benzoin alkyl ethers, di-ketones, phenones, and the like. Commercially available photoinitiators include, but not limited to, those available commercially from Ciba Geigy under the trade designations DARACUR 1173, DAROCUR 4265, IRGACURE 651, IRGACURE 184, IRGACURE 1800, IRGACURE 369, IRGACURE 1700, and IRGACURE 907, IRGACURE 819 and from Aceto Corp., Lake Success N.Y., under the trade designations UVI-6976 and UVI-6992. Phenyl-[p-(2-hydroxytetradecyloxy)phenyl]iodonium hexafluoroantomonate is a photoinitiator commercially available from Gelest, Tullytown, Pa. Phosphine oxide derivatives include LUCIRIN TPO, which is 2,4,6-trimethylbenzoy diphenyl phosphine oxide, available from BASF, Charlotte, N.C. In addition, further useful photoinitiators are described in U.S. Pat. Nos. 4,250,311, 3,708,296, 4,069,055, 4,216,288, 5,084,586, 5,124,417, 5,554,664, and 5,672,637. A photoinitiator can be used at a concentration of about 0.1 to 10 weight percent or about 0.1 to 5 weight percent based on the organic portion of the formulation (phr.)

The hardcoat layer described herein can be cured in an inert atmosphere. It has been found that curing the hardcoat layer in an inert atmosphere can assist in providing/maintaining the scratch and stain resistance properties of the hardcoat layer. In some embodiments, the hardcoat layer is cured with a UV light source under a nitrogen blanket.

To enhance durability of the hardcoat layer, especially in outdoor environments exposed to sunlight, a variety of commercially available stabilizing chemicals can be added. These stabilizers can be grouped into the following categories: heat stabilizers, UV light stabilizers, and free-radical scavengers. Heat stabilizers are commercially available from Witco Corp., Greenwich, Conn. under the trade designation “Mark V 1923” and Ferro Corp., Polymer Additives Div., Walton Hills, Ohio under the trade designations “Synpron 1163”, “Ferro 1237” and “Ferro 1720”. Such heat stabilizers can be present in amounts ranging from 0.02 to 0.15 weight percent. UV light stabilizers can be present in amounts ranging from 0.1 to 5 weight percent. Benzophenone type UV-absorbers are commercially available from BASF Corp., Parsippany, N.J. under the trade designation “Uvinol 400”; Cytec Industries, West Patterson, N.J. under the trade designation “Cyasorb UV1164” and Ciba Specialty Chemicals, Tarrytown, N.Y., under the trade designations “Tinuvin 900”, “Tinuvin 123” and “Tinuvin 1130”. Free-radical scavengers can be present in an amount from 0.05 to 0.25 weight percent. Nonlimiting examples of free-radical scavengers include hindered amine light stabilizer (HALS) compounds, hydroxylamines, sterically hindered phenols, and the like. HALS compounds are commercially available from Ciba Specialty Chemicals under the trade designation “Tinuvin 292” and Cytec Industries under the trade designation “Cyasorb UV3581”.

The cured hardcoat layer described above is disposed on a release liner comprising a release material. The release liner can have, as a base material, any useful material such as, for example, polymers or paper. Suitable materials for use in release coats are well known and include, but are not limited to, fluoropolymers, acrylics and silicons designed to facilitate the release of the release liner from the cured hardcoat layer. Additional useful release materials can be formed by irradiating (for example, by using an UV ray or electron beam) a release materiel precursor having shear storage modulus of about 1×10² Pa to about 3×10⁶ Pa at 20° C. and a frequency of 1 Hz. The release material (after irradiation) has a contact angle of 15° or more, measured using a mixed solution of methanol and water (volume ratio 90:10) having a wet tension of 25.4 mN/m. Examples of suitable release material precursors include polymers having a shear storage modulus within the above-described range, such as, for example, a poly(meth)acrylic ester, a polyolefin, or a polyvinyl ether.

An example of a useful release material precursor is a copolymer having two kinds of acryl monomer components such as, for example, a (meth)acrylate containing an alkyl group having from about 12 to about 30 carbon atoms (hereinafter referred to as a “first alkyl (meth)acrylate”) and a (meth)acrylate containing an alkyl group having from 1 to about 12 carbon atoms (hereinafter referred to as a “second alkyl (meth)acrylate”).

The first alkyl (meth)acrylate contains a relatively long alkyl side chain having from about 12 to about 30 carbon atoms that helps to decrease the surface energy of the release material. Accordingly, the first alkyl (meth)acrylate acts to impart a low release strength to the release material. The first alkyl (meth)acrylate typically does not contain a polar group (for example, a carboxyl group, a hydroxyl group, or a nitrogen- or phosphorous-containing polar group) on the side chain. Accordingly, the first alkyl (meth)acrylate can impart relatively low release strength to the release material, not only at low temperatures, but also even after exposure to relatively high temperatures.

Preferred examples of the first alkyl (meth)acrylate having a long chain alkyl group include lauryl (meth)acrylate, cetyl (meth)acrylate, (iso)octadecyl (meth)acrylate, and behenyl (meth)acrylate. The first alkyl (meth)acrylate is typically present in an amount of about 10% to about 90% by weight based on the total amount of the first alkyl (meth)acrylate and the second alkyl (meth)acrylate.

The second alkyl (meth)acrylate contains a relatively short alkyl side chain having from 1 to about 12 carbon atoms. This relatively short alkyl side chain decreases the glass transition temperature of the release material to about 30° C. or less. In turn, the release material precursor is reduced in crystallinity and also in the shear storage modulus.

In one embodiment, the second alkyl (meth)acrylate containing an alkyl group having 12 carbon atoms is the same as the first alkyl (meth)acrylate having 12 carbon atoms. In this case, unless other components are present, the release material can be formed from a release material precursor containing a homopolymer.

Furthermore, the second alkyl (meth)acrylate typically does not contain a polar group on the side. Therefore, similarly to the first alkyl (meth)acrylate, the second alkyl (meth)acrylate imparts a relatively low release strength, not only at a low temperature, but also at a relatively high temperature.

Preferred examples of the second (meth)acrylate having a short chain alkyl group include butyl (meth)acrylate, hexyl (meth)acrylate, octyl (meth)acrylate, and lauryl (meth)acrylate. The second alkyl (meth)acrylate is typically present in an amount of about 10% to about 90% by weight based on the total amount of the first alkyl (meth)acrylate and the second alkyl (meth)acrylate.

The first and/or the second alkyl (meth)acrylates may be a (meth)acrylate having a branched side chain such as 2-heptylundecyl acrylate, 2-ethylhexyl (meth)acrylate, or isononyl (meth)acrylate. (Meth)acrylates having a branched side chain reduce the crystallinity and therefore decrease the shear storage modulus and the surface energy. A homopolymer consisting of a monomer component of alkyl (meth)acrylate containing a branched alkyl group having from about 8 to about 30 carbon atoms can be useful as the release material precursor. For example, a homopolymer of 2-heptylundecyl acrylate is a preferred release material precursor from the standpoint that the obtained release material can be reduced in surface energy and shear storage modulus. A copolymer comprising a monomer component of alkyl (meth)acrylate containing a straight alkyl group and a monomer component of alkyl (meth)acrylate containing a branched alkyl group having from about 8 to about 30 carbon atoms can also be useful as the release material precursor. For example, a copolymer of stearyl acrylate and isostearyl acrylate is also a preferred release material precursor from the standpoint that the obtained release material can be reduced in surface energy and shear storage modulus.

Preferred release material precursors can be obtained by polymerization of alkyl (meth)acrylates in the presence of a polymerization initiator. The polymerization initiator is not particularly limited as long as it can bring about the polymerization. Examples of useful polymerization initiators include azobis compounds such as 2,2′-azobisisobutyronitrile, 2,2′-azobis(2-methylbutylonitrile), and 2,2′-azobis(2-methylvaleronitrile and peroxides such as benzoyl peroxide and lauroyl peroxide. Some polymerization initiators are commercially available, such as 2,2′-azobisisobutyronitrile and 2,2′-azobis(2-methylbutylonitrile), which are available as V-60 and V-59 from Wako Pure Chemical Industries, Ltd. (Osaka, Japan). The amount of polymerization initiator can vary, but the polymerization initiator is typically used in an amount of about 0.005% to about 0.5% by weight based on the weight of the monomer.

The polymerization of the above-described alkyl (meth)acrylates can be performed by any known method. For example, a solution polymerization method, which involves dissolving the alkyl (meth)acrylates in a solvent and polymerizing them in solution can be used. The polymer solution can be directly taken out and used after the completion of polymerization. In this case, the solvent to be used is not particularly limited. Some examples of suitable solvents include ethyl acetate, methyl ethyl ketone, and heptane. A chain transfer agent can also be incorporated into the solvent in order to control molecular weight. The solution polymerization of the polymerizable composition can typically be performed at a reaction temperature of about 50° C. to about 100° C. for about 3 to about 24 hours in an atmosphere of an inert gas such as nitrogen.

When the release material precursor is a poly(meth)acrylate, the release material polymer typically has a weight average molecular weight of about 100,000 to about 2,000,000. If the weight average molecular weight is less than about 100,000, the release strength may increase, whereas if the weight molecular average molecular weight exceeds about 2,000,000, the viscosity of the polymer solution may be increased during synthesis, making handling of the polymer solution relatively difficult.

As long as the above-described physical properties can be attained, the release material can be constituted by a polyolefin. The polyolefin can be formed from an olefin monomer having from about 2 to about 12 carbon atoms. Examples of useful olefin monomers include linear olefins such as ethylene, propylene, 1-butene, 1-pentene, 1-hexene, 1-heptene, 1-octene, 1-nonene, 1-decene, 1-undecene, 1-dodecene, and branched olefins such as 4-methyl-1-pentene, 5-methyl-1-hexene, 4-methyl-1-hexene, 7-methyl-1-octene, and 8-methyl-1-nonene. However, a homopolymer of ethylene or propylene, namely polyethylene and polypropylene, generally cannot satisfy the physical properties of shear storage modulus because of their crystallinity. Therefore, when using ethylene, propylene, or the like, the shear storage modulus is typically decreased by copolymerization, for example, with 1-butene, 1-octene, or the like.

With respect to the copolymer structure, a random copolymer is preferred from the standpoint of reducing crystallinity. However, even if the copolymer has crystallinity, as long as the shear storage modulus is acceptable, a block copolymer can be used. The weight average molecular weight is typically from about 100,000 to about 2,000,000. Polyolefins having a high molecular weight can be produced by conventionally known polymerization methods such as, for example, ionic polymerization, preferably coordinated anionic polymerization.

Examples of useful commercially available polyolefins include ethylene/propylene copolymers are available from JSR Corporation (Tokyo, Japan) as EP01P and EP912P, and an ethylene/octene copolymer available from The Dow Chemical as Engage™ 8407.

The release material precursor can also be a polyvinyl ether having the above-described properties. Examples of the starting monomer for a polyvinyl ether include linear or branched vinyl ethers such as n-butyl vinyl ether, 2-hexyl vinyl ether, dodecyl vinyl ether, and octadecyl vinyl ether. However, for example, polyoctadecyl vinyl ether does not satisfy the above-described physical properties for the shear storage modulus. Therefore, when using octadecyl vinyl ether, the shear storage modulus is typically decreased by copolymerization, for example, 2-ethylhexyl vinyl ether.

With respect to the copolymer structure, a random copolymer is preferred from the standpoint of reducing crystallinity. However, even if the copolymer has crystallinity, as long as the shear storage modulus is acceptable, a block copolymer can be used. The weight average molecular weight is typically from about 100,000 to about 2,000,000. The polyvinyl ether can be produced by ionic polymerization such as, for example, by cationic polymerization.

The release material precursor can be provided on a liner substrate, preferably a liner substrate comprising polyester, polyolefin, or paper. The release material precursor can then be subjected to a treatment of radiation, for example, by using an electron beam or UV rays. The release material precursor generally has no polar functional groups such as carboxyl groups, hydroxyl groups, or amide groups. Therefore, it would be expected that the release material precursor would exhibit poor anchoring to the liner substrate. However, despite the absence of a polar functional group in the release material precursor, the anchoring between the liner substrate and the release material can be increased by treatment with radiation.

The release liner can be manufactured as follows. A solution of the release material precursor can be diluted with a diluent, for example, containing at least one of ethyl acetate, butyl acetate, methyl ethyl ketone, methyl isobutyl ketone, hexane, heptane, toluene, xylene, and methylene chloride, and then coated to a predetermined thickness, thereby forming a release material precursor layer on the liner substrate. The diluent can be the same as or different than the solvent used in the solution polymerization.

Examples of liner substrates that can be used include plastics such as polyesters (for example, a polyethylene terephthalate, polyethylene naphthalate, or polybutylene terephthalate film) and polyolefins, and paper. The thickness of the release material precursor depends on the type of liner substrate but is generally from about 0.01 to about 1 μm (preferably, from about 0.05 to about 0.5 μm).

The release material precursor can be irradiated by, for example, an electron beam or ultraviolet ray. In the case of using an electron beam, the irradiation is typically performed under an inert gas such as nitrogen. The absorbed dose thereto depends on the thickness and composition of the release material precursor layer and is usually from about 1 to about 100 kGy. If an ultraviolet ray is used, the irradiation energy of the release material precursor layer is usually from about 10 to about 300 mJ/cm² (preferably, from about 20 to about 150 mJ/cm²).

An example of another useful release material precursor is an acrylic release agent precursor which comprises a poly(meth)acrylate ester having a group capable of being activated by ultraviolet radiation (also referred to as “an ultraviolet active group”) and has a shear storage modulus of about 1×10² to about 3×10⁶ Pa at 20° C. and a frequency of 1 Hz. The acrylic release agent precursor, after irradiation with ultraviolet radiation, has a contact angle of about 15° or more to a mixed solution of methanol and water (volume ration of 90:10) having a wetting tension of 25.4 mN/m.

The acrylic release agent precursor can be a polymer composition comprising a polymer such as poly(meth)acrylate ester having an ultraviolet active group. The poly(meth)acrylate is, for example, a copolymer formed from a first alkyl (meth)acrylate as described above, a second alkyl (meth)acrylate as described above, and a (meth)acrylate ester having an ultraviolet active group.

Preferred first alkyl (meth)acrylates containing a long alkyl side chain for the acrylic release agent precursor include lauryl (meth)acrylate, cetyl (meth)acrylate, stearyl (meth)acrylate, and behenyl (meth)acrylate.

The copolymer typically contains the first alkyl (meth)acrylate or second alkyl (meth)acrylate in an amount from about 10 to about 90% by weight based on the total weight of the first and second alkyl (meth)acrylates.

The poly (meth)acrylate ester can also be derived from a monomer component containing an alkyl (meth)acrylate having a branched alkyl group having from about 8 to about 30 carbon atoms and a (meth)acrylate ester having an ultraviolet active group. Examples of suitable alkyl (meth)acrylate having a branched alkyl group include 2-ethylhexyl (meth)acrylate, 2-hexyldodecyl acrylate, 2-heptylundecyl acrylate, 2-octyldecyl acrylate, and isononyl (meth)acrylate.

Such a (meth)acrylate having a branched side chain can reduce the shear storage modulus and surface energy by lowering the crystallinity. Thus, it is not necessary for the acrylic release agent precursor to contain two components such as a first alkyl (meth)acrylate and a second alkyl (meth)acrylate described above if it has a branched alkyl group having from about 8 to about 30 carbon atoms. For example, the polymer of 2-hexyldecyl acrylate or 2-octyldecyl acrylate can reduce the surface energy of the release agent.

Typically, the monomer component has no polar groups on the side chain. However, the monomer component may, for example, have a polar functional group on the side chain as long as the acrylic release agent precursor has a shear storage modulus as described above.

The poly(meth)acrylate ester has an ultraviolet active group. This ultraviolet active group can generate a free radical in the acrylic release agent precursor by irradiation with ultraviolet radiation. The generated free radical promotes crosslinking of the acrylic release agent precursor and adhesion to the liner substrate, resulting in an improvement in adhesion between the liner substrate and the release agent. Preferably, the amount of the (meth)acrylate ester having an ultraviolet active group is within a range of about 0.01 to about 1% by weight per poly(meth)acrylate ester unit.

The ultraviolet active group is not specifically limited, but is preferably derived from benzophenone or acetophenone. Introduction of the ultraviolet active group into the poly(meth)acrylate ester can be conducted by incorporating a (meth)acrylate ester having an ultraviolet active group as a monomer component and polymerizing the monomer component containing the (meth)acrylate ester.

The polymer of the acrylic release agent precursor preferably has a weight-average molecular weight within a range from about 100,000 to about 2,000,000.

The monomer component described above can be polymerized in the presence of a polymerization initiator to form an acrylic release agent precursor. Preferably, the polymerization is solution polymerization. Solution polymerization can typically be conducted in the state where the monomer component is dissolved in a solvent, together with the polymerization initiator, in an atmosphere of an inert gas such as nitrogen at about 50° to about 100° C. Solvents such as, for example, ethyl acetate, methyl ethyl ketone, or heptane can be used. Optionally, the molecular weight of the polymer can be controlled by adding a chain transfer agent to the solvent.

The polymerization initiator is not specifically limited. For example, an azobis compound such as 2,2′-azobisisobutyronitrile, 2,2′-azobis(2-methylbutyronitrile) or 2,2′-azobis(2,4-dimethylvaleronitrile), dimethyl 2,2′-azobis(2-methylpropionate) and a peroxide such as benzoyl peroxide or lauroyl peroxide can be used as the polymerization initiator. Preferably, the polymerization initiator is used in the amount within a range from 0.005 to 0.5% by weight based on the total weight of the monomer component.

The acrylic release agent precursor as described above is converted into an acrylic release agent by irradiating with ultraviolet radiation, after the precursor is coated on a liner substrate. Typically, the acrylic release agent is formed on the liner substrate in the thickness within a range from 0.01 to 1 μm. The acrylic release agent is generally obtained by irradiating with ultraviolet radiation after coating with the acrylic release agent precursor. As disclosed in WO 01/64805 and/or KOKAI (Japanese Unexamined Patent Publication) No. 2001-240775, the acrylic release agent adheres to the liner substrate by the irradiation with ultraviolet radiation, even though the acrylic release agent typically has no polar functional group. The liner substrate can be, for example, a film made of plastic such as polyester or polyolefin (for example, polyethylene terephthalate, polyethylene naphthalate or polybutylene terephthalate) or a paper. Preferred thickness of the liner substrate is within a range from about 10 to about 300 μm.

Usually, the acrylic release agent precursor is produced by solution polymerization as described above and exists in the state of a polymer solution. Therefore, the liner substrate can be coated with the polymer solution in a thickness typically within a range from about 0.01 to about 1 μm (preferably from 0.05 to 0.5 μm), using coating means such as bar coater. If necessary, the polymer solution can be applied after diluting with a diluent until a predetermined viscosity is achieved. Examples of the diluent include ethyl acetate, butyl acetate, methyl ethyl ketone, methyl isobutyl ketone, hexane, heptane, toluene, xylene, and methylene chloride.

The acrylic release agent precursor applied as described above is converted into an acrylic release agent by irradiation with ultraviolet radiation. The dose of irradiation with ultraviolet radiation varies depending on the kind and structure of the poly(meth)acrylate, but can usually be a low dose within a range from 10 to 150 mJ/cm².

In some embodiments, the release liner has a micro-structured surface (not shown). In these embodiments, the cured hardcoat layer can have a corresponding micro-structured surface. Providing a release liner with a micro-structured surface can allow for a corresponding hardcoat layer micro-structured surface for the purposes of providing a matte finish to the hardcoat layer or for providing the hardcoat layer with other desired optical properties. The microstructures can be any useful microstructure that is disposed in a regular or random pattern across the surface of the release liner (and the corresponding hardcoat layer surface disposed on the micro-structured release liner) and can have micro-structured width and height independently selected from a range of 1 to 1000 micrometers, or 5 to 500 micrometers, or 10 to 100 micrometers. These micro-structures can be formed on the release liner by any useful method such as, for example, embossing or molding of the release liner.

We claim:

1. A hardcoat film article comprising a cured hardcoat layer disposed on a release liner, and a thermoplastic layer on the cured hardcoat layer opposite the release liner, the release liner comprising a release material formed by irradiating a release material precursor,
wherein the thermoplastic layer has a thickness of at least about 25 micrometers,
the release material precursor has a shear storage modulus of about 1×10² to about 3×10⁶ Pa when measured at 20° C. and at a frequency of 1 Hz, and
the release material has a contact angle of 15° or more, as measured using a mixed solution of methanol and water (volume ratio 90:10) having a wet tension of 25.4 mN/m.

2. A film according to claim 1 wherein the cured hardcoat layer comprises a cross-linked multi-functional polyacrylate and a polyurethane.

3. A film according to claim 1 wherein the release liner has a micro-structured surface and the cured hardcoat layer has a corresponding micro-structured surface.

4. A hardcoat film article comprising a cured hardcoat layer disposed on a release liner, and a thermoplastic layer on the cured hardcoat layer opposite the release liner, the release liner comprising a release material formed by irradiating a release material precursor,
wherein the thermoplastic layer is opaque,
the release material precursor has a shear storage modulus of about 1×10² to about 3×10⁶ Pa when measured at 20° C. and at a frequency of 1 Hz, and
the release material has a contact angle of 15° or more, as measured using a mixed solution of methanol and water (volume ratio 90:10) having a wet tension of 25.4 mN/m.

5. A film according to claim 4 wherein the cured hardcoat layer comprises a cross-linked multi-functional polyacrylate and a polyurethane.

6. A film according to claim 4 wherein the release liner has a micro-structured surface and the cured hardcoat layer has a corresponding micro-structured surface.

7. A method of forming a composite film comprising:
providing a release liner;
coating a hardcoat composition onto the release liner to form a hardcoat layer;
curing the hardcoat layer to form a cured hardcoat layer;
disposing an opaque thermoplastic layer onto the cured hardcoat layer to form a hardcoat composite film; and
attaching the hardcoat composite film to an adhesive layer opposite the cured hardcoat layer.

8. A method according to claim 7 further comprising a second release liner on the adhesive, opposite the hardcoat composite film.

9. A method according to claim 7 wherein the disposing step comprises casting a thermoplastic layer directly onto the cured hardcoat layer to form a transparent hardcoat composite film.

10. A method according to claim 7 wherein the curing step comprises curing the hardcoat layer to form a cured hardcoat layer having a thickness in a range from 1 to 15 micrometers.

11. A method of forming a composite film comprising:
providing a release liner;
coating a hardcoat composition onto the release liner to form a hardcoat layer;
curing the hardcoat layer to form a cured hardcoat layer;
disposing a thermoplastic layer onto the cured hardcoat layer to form a hardcoat composite film; and
attaching the hardcoat composite film to an adhesive layer opposite the cured hardcoat layer,
wherein the thermoplastic layer has a thickness of at least 25 micrometers.

12. A method according to claim 11 further comprising a second release liner on the adhesive, opposite the hardcoat composite film.

13. A method according to claim 11 wherein the disposing step comprises casting a thermoplastic layer directly onto the cured hardcoat layer to form a transparent hardcoat composite film.

14. A method according to claim 11 wherein the curing step comprises curing the hardcoat layer to form a cured hardcoat layer having a thickness in a range from 1 to 15 micrometers.

15. A hardcoat composite film comprising:
a release liner;
a stain and scratch resistant cured hardcoat layer disposed on the release liner, the cured hardcoat layer having a thickness in a range from 1 to 15 micrometers; and
a thermoplastic layer on the cured hardcoat layer, the thermoplastic layer having a thickness of at least about 25 micrometers.

16. A composite film according to claim 15 wherein the cured hardcoat layer comprises a cross-linked multi-functional polyacrylate and a polyurethane.

17. A composite film according to claim 15 wherein the release liner has a micro-structured surface and the cured hardcoat layer has a corresponding micro-structured surface.

18. A composite film according to claim 15 wherein the thermoplastic material is opaque.

19. A composite film according to claim 15 comprising an adhesive layer on the thermoplastic layer opposite the cured hardcoat layer.

20. A composite film according to claim 19 comprising a second release liner on the adhesive layer opposite the thermoplastic layer.
